(19) United States
(12) Patent Application Publication
(10) Pub. No.: US 2013/0322812 A1
(43) Pub. Date: Dec. 5, 2013

(54) OPTICAL PRINTED CIRCUIT BOARD AND METHOD FOR MANUFACTURING SAME

(71) Applicant: BING-HENG LEE, Tu-Cheng (TW)

(72) Inventor: BING-HENG LEE, Tu-Cheng (TW)

(21) Appl. No.: 13/653,612

(22) Filed: Oct. 17, 2012

(30) Foreign Application Priority Data
May 31, 2012 (TW) 101119442

(51) Int. Cl. G02B 6/12; B32B 38/04; B32B 38/10

(52) U.S. Cl. 385/14; 156/249

(57) ABSTRACT

An optical printed circuit board includes a flexible substrate and a flexible optical wave guide. The flexible substrate includes a flexible sheet and a copper layer set on the flexible sheet. A part of the copper layer is removed for receiving the flexible optical wave guide. The flexible optical wave guide sets on the flexible sheet at the position where the part of the copper layer is removed.

### BACKGROUND

1. Technical Field

The present disclosure relates to an optical printed circuit board and a method for manufacturing the optical printed circuit board.

2. Description of Related Art

A flexible optical printed circuit board (FOPCB) can transmit more information than a traditional printed circuit board (PCB). Therefore, the FOPCB is used to transmit information in electronic devices. Yet, the FOPCB can only transmit optical signals, but cannot transmit electrical signals.

Therefore, it is desired to provide an optical printed circuit board and a method for manufacturing the optical printed circuit board which can overcome the above-mentioned problems.

### BRIEF DESCRIPTION OF THE DRAWINGS

FIG. 1-12 are schematic views showing successive stages of a method of manufacturing an optical printed circuit board according to an exemplary embodiment, wherein FIG. 2 is a cross-sectional view taken along line II-II of FIG. 1.

### DETAILED DESCRIPTION

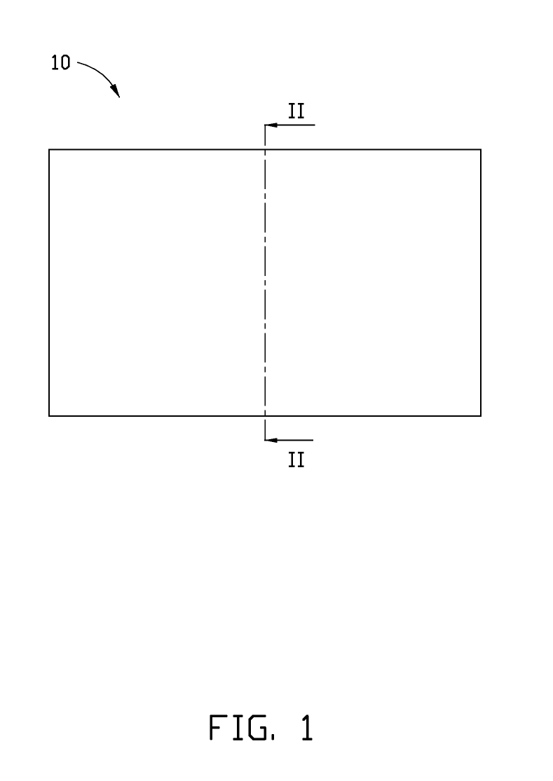

FIGS. 1-12 show successive stages of a method for manufacturing an optical printed circuit board according to an exemplary embodiment. The method includes steps as follows.

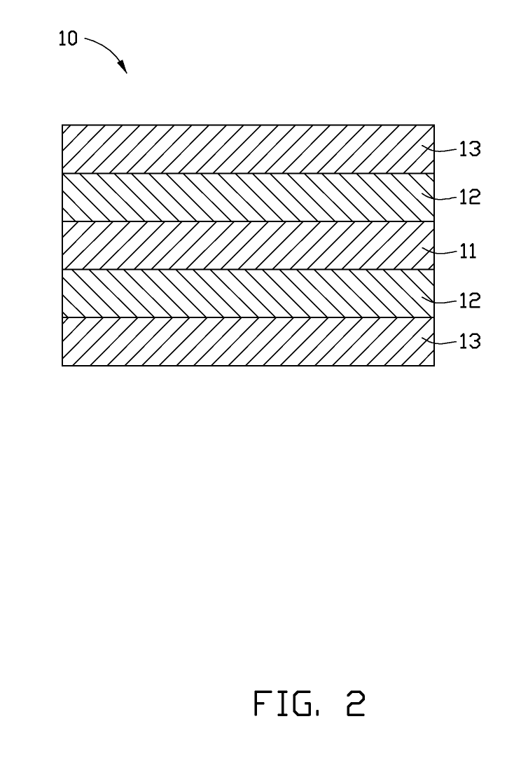

In step 1, as shown in FIGS. 1 and 2, a flexible substrate 10 is provided. The flexible substrate 10 includes a flexible sheet 11, two adhering layers 12 coated on two opposite surfaces of the flexible sheet 11, and two copper layers 13 adhered to the two adhering layers 12 respectively. The flexible sheet 11 is made of polyethylene terephtalate (PET).

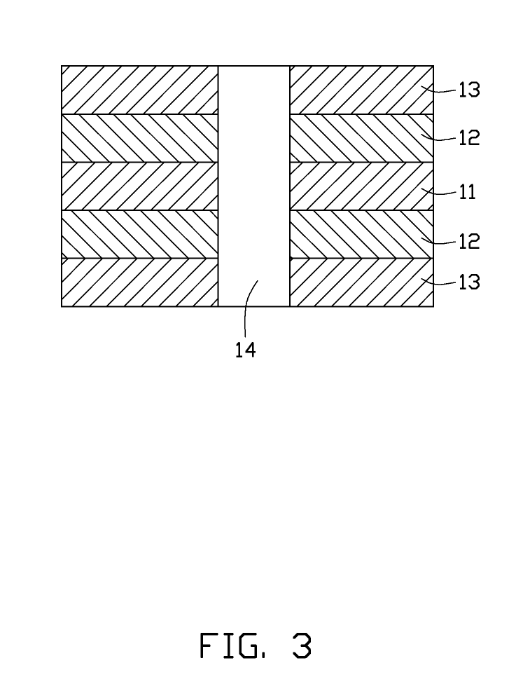

In step 2, as shown in FIG. 3, a through hole 14 is formed in the flexible substrate 10 by means of stamping.

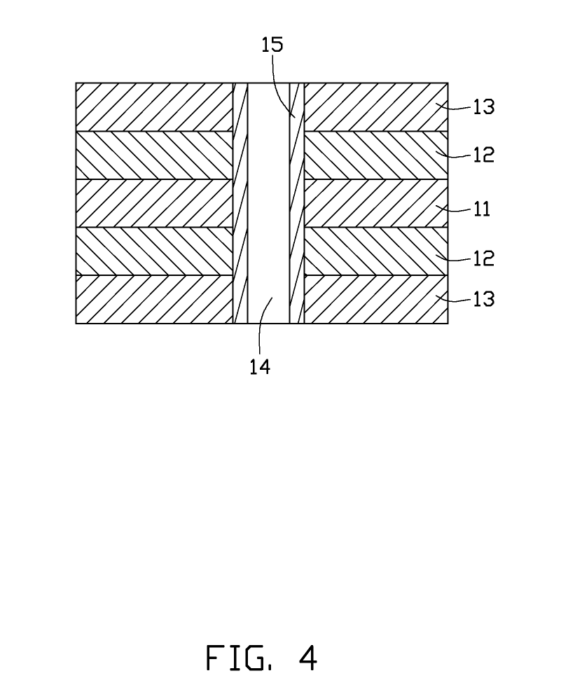

In step 3, as shown in FIG. 4, a conductive film 15 is coated on an inner surface of the through hole 14 for electrically connecting the two copper layers 13. The conductive film 15 is made of conductive material, such as copper.

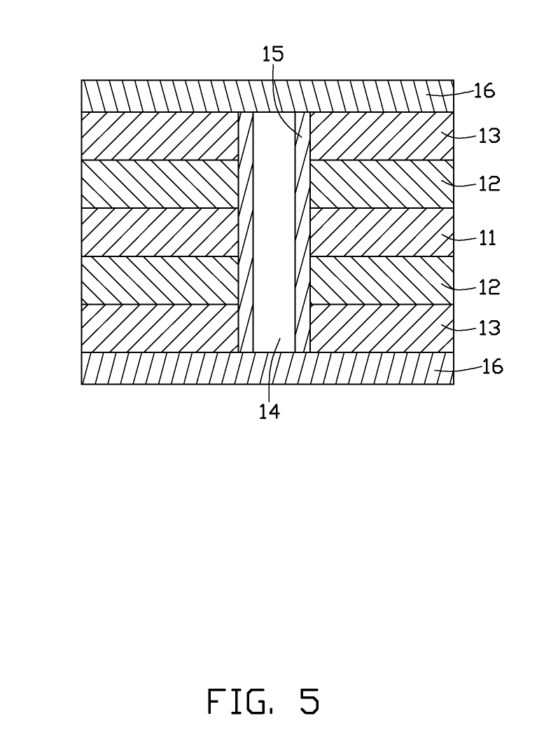

In step 4, as shown in FIG. 5, two photosensitive layers 16 are set on the two copper layers 13 and ends of the conductive film 15 by means of hot pressing. In this embodiment, the photosensitive layers 16 are made of acrylic photoresist.

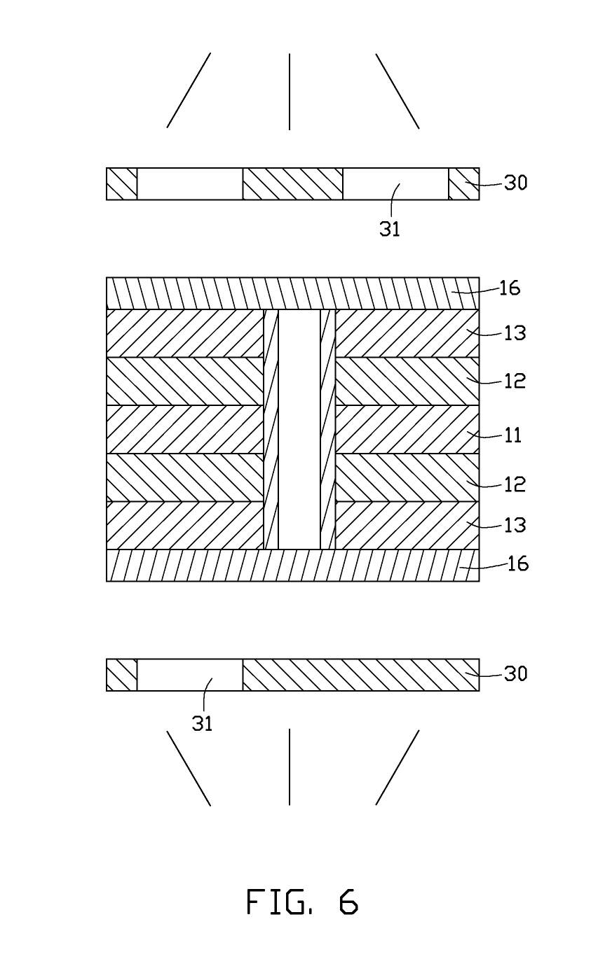

In step 5, as shown in FIG. 6, parts of the photosensitive layers 16 are exposed to light. In this embodiment, optical masks 30 are put on the photosensitive layers 16. The optical masks 30 define holes 31. The light passes through the holes 31 to illuminate the parts of the photosensitive layers 16.

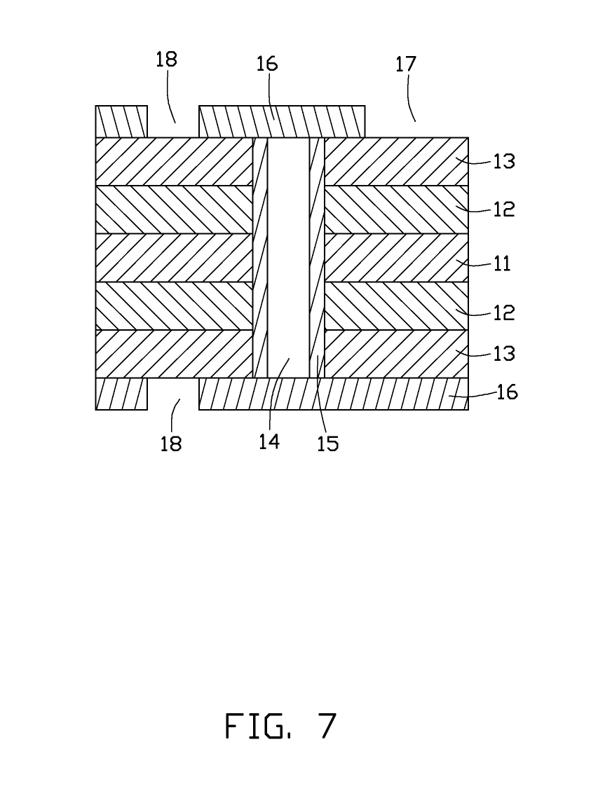

In step 6, as shown in FIG. 7, each of the photosensitive layers 16 is developed to obtain a first developed area 17 and a second developed area 18. In this embodiment, the flexible substrate 10 is put in an etching liquid. The parts of each of the photosensitive layers 16 which are exposed to light are removed to obtain the first developed area 17 and the second developed area 18. In the first developed area 17 and the second developed area 18, the copper layers 13 are exposed.

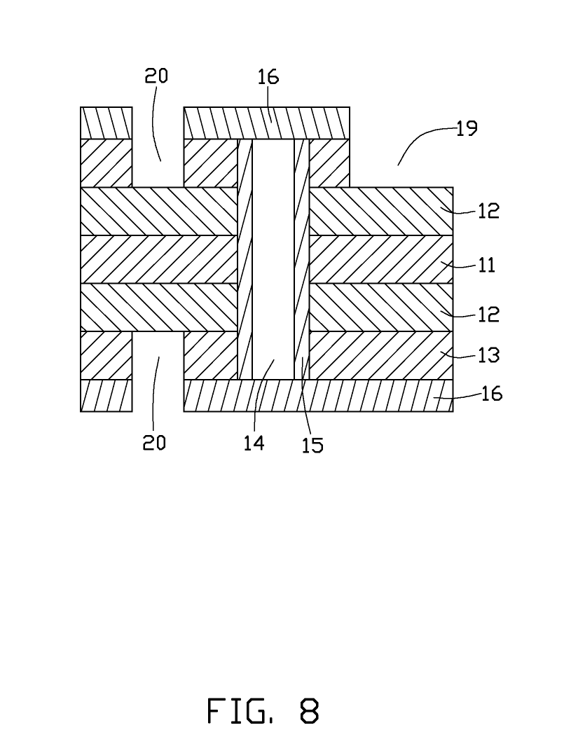

In step 7, as shown in FIG. 8, each of the copper layers 13 at the first developed area 17 and the second developed area 18 of the respective photosensitive layer 16 is removed by means of etching, to obtain an optical wave guide area 19 and a circuit area 20.

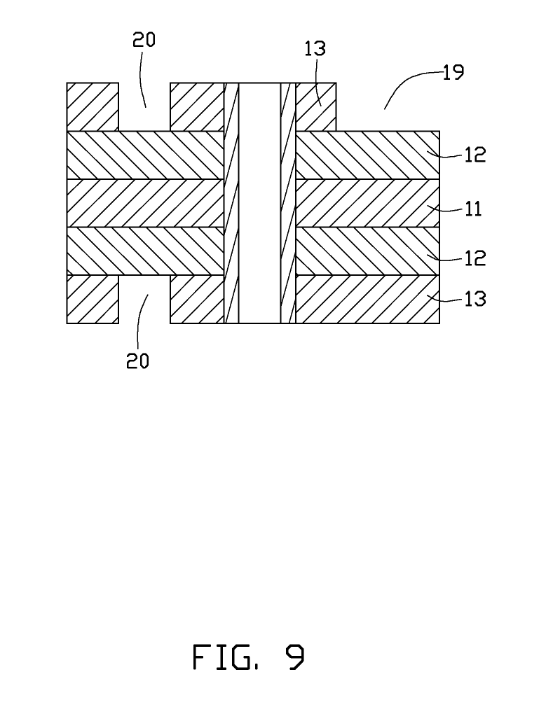

In step 8, as shown in FIG. 9, the remaining photosensitive layers 16 are removed by means of etching.

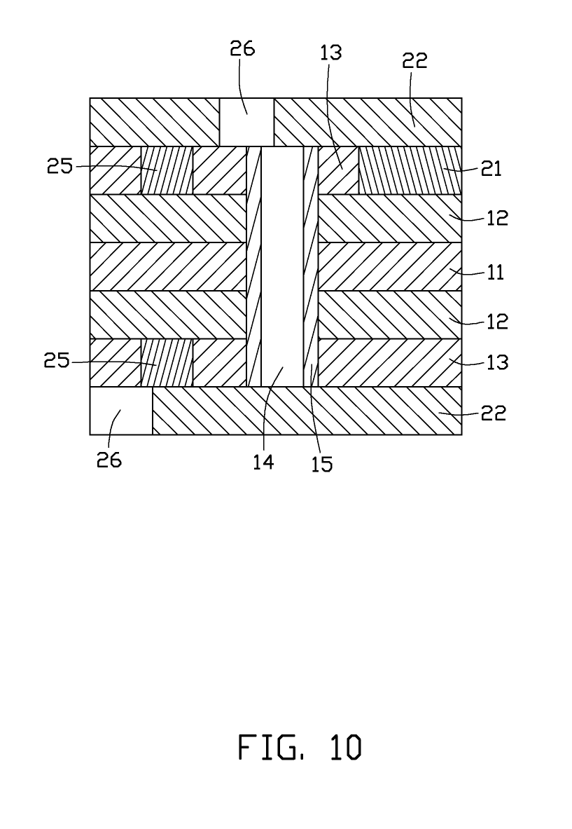

In step 9, as shown in FIG. 10, a flexible optical wave guide 21 is put at the optical wave guide area 19, adhesives 25 are applied to the circuit area 20, and two insulation layers 22 are adhered to the two copper layers 13 by means of hot pressing. The insulation layers 22 cover the flexible optical wave guide 21 and the copper layers 13, and define electrode holes 26 corresponding to the copper layers 13.

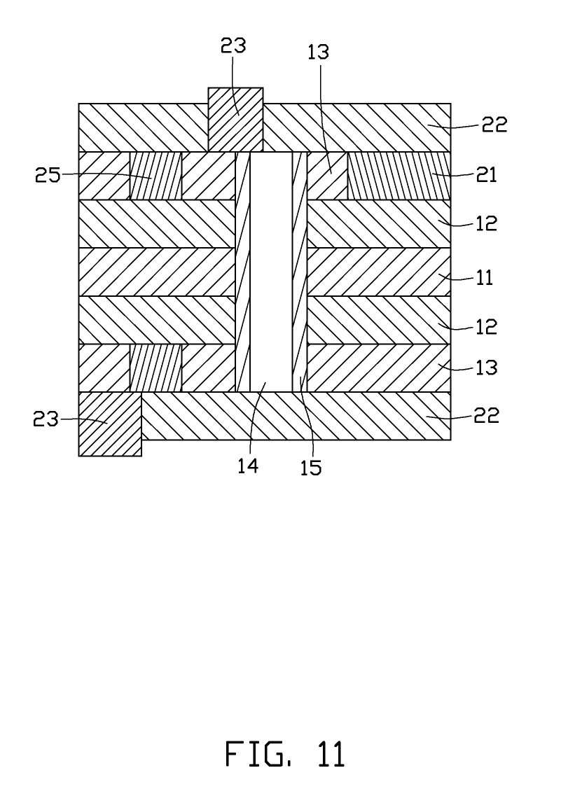

In step 10, as shown in FIG. 11, electrode films 23 are coated in the electrode holes 26. The electrode films 23 are made of conductive material, such as copper, and are electrically connected with the copper layers 13.

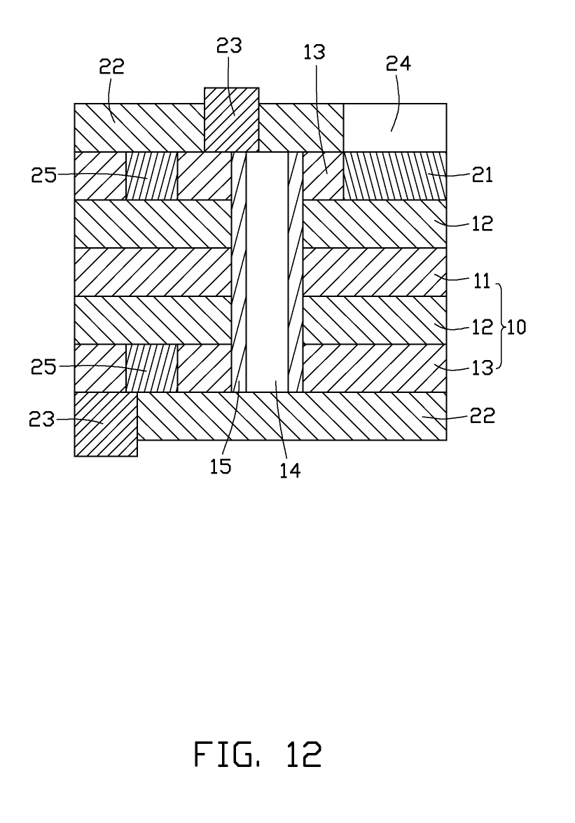

In step 11, as shown in FIG. 12, light holes 24 are formed in the insulation layers 22 at the position aligned with the flexible optical wave guide 21. Therefore, an optical printed circuit board is obtained.

An electrical signal can be transmitted by the electrode films 23 and the copper layers 13. An optical signal can pass through the light holes 24, and then is transmitted in the flexible optical wave guide 21. Thus, the optical printed circuit board can transmit the electrical signal and the optical signal both.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A method for manufacturing an optical printed circuit board, comprising:
providing a flexible substrate, the flexible substrate comprising a flexible sheet, a first copper layer, and a second copper layer, the first and second copper layers positioned at two opposite sides of the flexible sheet;
forming a through hole in the flexible substrate, the through hole passing through the flexible sheet and the first and second copper layers;
coating a conductive film on an inner surface of the through hole, the conductive film electrically connecting to the first and second copper layers;
positioning a photosensitive layer on the first copper layer;
forming a developed area on the photosensitive layer, a portion of the first copper layer at the developed area being exposed;
removing the portion of the first copper layer at the developed area to obtain an optical wave guide area in the first copper layer;
removing the photosensitive layer;
forming a flexible optical wave guide in the optical wave guide area;
adhering an insulating layer on the first copper layer; and
forming a light hole in the insulating layer aligned with the flexible optical wave guide.

2. The method of claim 1, wherein the flexible substrate further comprises two adhering layers, each of the adhering layers adhering a respective one of the copper layers to the flexible sheet.

3. The method of claim 1, wherein in the step of forming a developed area on the photosensitive layer, another developed area is formed on the photosensitive layer, and the first copper layer at the another developed area is exposed.

4. The method of claim 3, wherein in the step of removing the portion of the first copper layer at the developed area to obtain an optical wave guide area in the first copper layer, the first copper layer at the another developed area is removed to obtain a circuit area.

5. The method of claim 4, further comprising a step of applying adhesives in the circuit area before the step of adhering an insulating layer on the first copper layer.

6. The method of claim 1, wherein the insulating layer defines electrode holes.

7. The method of claim 6, further comprising a step of coating electrode films in the electrode holes, the electrode films being electrically connected to the first copper layer.

8. An optical printed circuit board, comprising:
a flexible substrate comprising:
a flexible sheet;
a first copper layer; and
a second copper layer; wherein
the first and second copper layers are positioned on two opposite sides of the flexible sheet, the flexible substrate defines a through hole passing through the flexible sheet, the first copper sheet, and the second copper sheet, the flexible substrate comprises a conductive film on an inner surface of the through hole, the conductive film is electrically connected to the first and second copper layers, a part of the first copper layer is removed; and
a flexible optical wave guide set on the flexible sheet at the position where the part of the first copper layer is removed.

9. The optical printed circuit board of claim 8, wherein the flexible substrate further comprises two adhering layers, each of the adhering layers adheres a respective one of the first and second copper layers to the flexible sheet.

10. The optical printed circuit board of claim 8, further comprising an insulating layer on the first copper layer and the flexible optical wave guide.

11. The optical printed circuit board of claim 10, wherein the insulating layer defines a light hole aligned with the flexible optical wave guide.

12. The optical printed circuit board of claim 10, wherein the insulating layer defines electrode holes therein; the optical printed circuit board comprises electrode films in the electrode holes and electrically connected with the first copper layer.
